(19) United States
(12) Patent Application Publication
(10) Pub. No.: US 2010/0106537 A1
(43) Pub. Date: Apr. 29, 2010

(54) Detecting Potentially Unauthorized Objects Within An Enterprise

(76) Inventors: Kei Yuasa, Sunnyvlae, CA (US); Evan R. Kirshenbaum, Mountain View, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/256,586

(22) Filed: Oct. 23, 2008

(51) Int. Cl. G06Q 10/00

(52) U.S. Cl. 705/7

(57) ABSTRACT

One embodiment is a method that observes a first object within an enterprise and then determines that use of the first object by an enterprise is potentially unauthorized. The method then alters a computer model based on the first object and determines based on the model that a second object within the enterprise is potentially unauthorized.

### BACKGROUND

In large organizations, an enormous number of documents are created, and many of these documents include images (photographs, drawings, charts, etc.) As the global Web contains a nearly limitless stock of images and search engines make it relatively simple to find just the right image for any situation, increasingly, generated documents incorporate images that the author and the entity are not licensed to use. Use of such copyrighted documents poses a potential liability for companies. When such a document is released to the outside world (as by being included in a published paper or book, placed on a web site, emailed to a recipient outside of the enterprise, or presented to a customer), the liability can be significant.

Preventing such liability is further compounded by two further issues. First, the person exposing the document may not be the author of the document and so may be unaware of the copyright/licensing status of images used in the document. Second, within an organization, documents are frequently created by modifying existing documents produced by other individuals. After several rounds of these modifications, the person who originally brought the document into the organization may no longer be involved. Furthermore, images can be so frequently used within the organization that individuals mistakenly believe that such images are legitimate, original, and not subject to copyright ownership of a third party.

### BRIEF DESCRIPTION OF THE DRAWINGS

FIG. 1 is a block diagram of a computer system with an enterprise in accordance with an exemplary embodiment of the present invention.

FIG. 2 is a system for monitoring documents in an enterprise in accordance with an exemplary embodiment of the present invention.

FIG. 3 is a flow diagram for determining an origin of objects in an enterprise in accordance with an exemplary embodiment of the present invention.

FIG. 4 is a block diagram of an exemplary computer system in accordance with an embodiment of the present invention.

### DETAILED DESCRIPTION

Exemplary embodiments in accordance with the present invention are directed to systems and methods for monitoring and observing objects, documents, files, and images in an enterprise.

One exemplary embodiment detects when documents (including email messages, customer-facing presentations, web sites, books, etc.) contain images that represent potential copyright problems due to the use of imported images being copyrighted or belonging to a third party (i.e., a person or organization other than the enterprise). Transmission paths (e.g., email, web browsing, and installed software) from outside the enterprise are monitored to detect when images, documents, or other types of objects enter the enterprise. As used herein, an object is any set of digital data. This specification primarily discusses images, but it should be understood that references to images are to be construed to include other objects, including (but not limited to) audio clips or songs, video clips or movies, text (including text derived by optical character recognition from images scanned from printed sources), source code, compiled object code, database records, models (e.g., animation models), and data (e.g., credit card numbers, addresses, or medical or purchasing histories). An assumption is made that objects entering the enterprise are subject to potential copyright ownership of third parties. Exemplary embodiments provide systems and methods to monitor and analyze such documents to determine whether such documents contain objects that are potentially subject to copyright ownership of a third party. One embodiment provides a mechanism that determines whether a given image is sufficiently similar to a potentially unauthorized image to warrant attention, notification, or further investigation of ownership or right to use of the object. In this specification, an object is “unauthorized” if its use or disclosure inside or outside an enterprise could subject the enterprise, its employees, or any other entity to embarrassment, prosecution, loss, or other harm due to factors including (but not limited to) violation of copyright, trademark, or patent, breach of law, contract, or agreement, or disclosure of secret, sensitive, confidential, or private information. A determination of whether an object is unauthorized is task specific. An object can be unauthorized for some purposes (for example, a presentation outside the enterprise) but authorized for other purposes (for example, a presentation within the enterprise). An object is “potentially unauthorized” if it is believed, but not known with certainty to be unauthorized. It is “authorized” if it is known (or believed) to not be unauthorized. A determination that an object is authorized does not necessarily imply that there may not be other bars to it being used that are beyond the scope of the method (for example, requiring signatures or following corporate procedures).

Using copyrighted work without proper authorization or right to use can produce liability for an enterprise or individual. A vast majority of copyrighted images do not actually indicate their copyright status. In addition, an image may be associated with a web site (or other document) that indicates a copyright status, but that copyright status may not apply to the image. In order for a document containing such an image (or an image or derivative work derived from such an image) to leave an enterprise, the image first enters the enterprise. Images typically enter the enterprise over a web (HTTP: Hypertext Transfer Protocol) connection, via inbound email, or by being installed as part of a piece of software. One embodiment monitors some or all of these ways images enter into the enterprise. This monitoring produces a representation of images known to exist outside the enterprise. Any image that is sufficiently close in kind or similar to one of these images causes an indication of potential copyright violation.

Exemplary embodiments are not limited to detecting copyrighted images or documents but include detecting and/or monitoring unauthorized images or documents. By way of example, unauthorized includes, but is not limited to, images or documents that are confidential, secret, private, classified, disclosing of personal information, obtained under an agreement that mandates non-disclosure, etc.

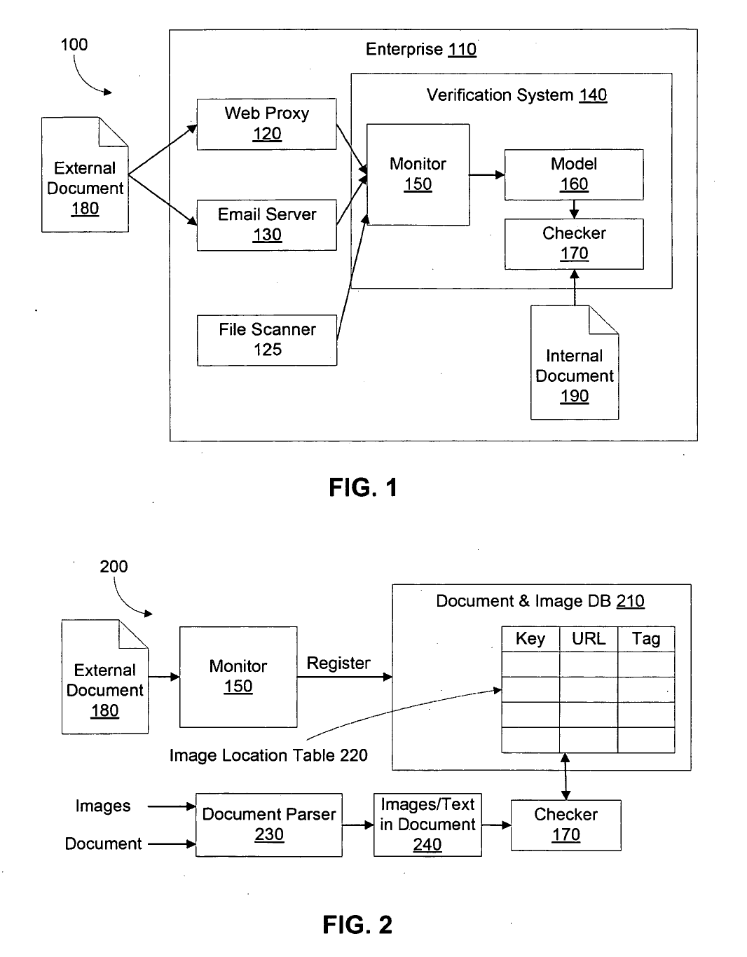

FIG. 1 is a block diagram of a computer system 100 with an enterprise 110 in accordance with an exemplary embodiment of the present invention. The enterprise includes a web proxy 120, a file scanner 125, and an email server 130 connected to a verification system 140. The verification system 140 includes a monitor 150, a model 160, and a checker 170.

The verification system 140 notes the entry of external images 180 and makes judgments about the copyright status of images contained in internal documents 190 in the enterprise 110.

The monitor 150 discovers images believed or assumed to be potentially unauthorized. Unauthorized images include, for example, images subject to a third party copyright without a license or right to use. Electronic external images 180 entering the enterprise 110 transmit to either the web proxy 120 or the email server 130.

These images are then routed to the verification system 140 and, in particular, the monitor 150. The place or method at or by which an image enters the enterprise is called an “entry point” to the enterprise.

The monitor 150 analyzes the images and based on the analysis updates the model 160, such as a database or other storage. The models of images as seen by the monitor 150 are updatable as new images are discovered.

The checker 170 uses the model 160 to determine whether a given document should be considered potentially unauthorized or whether a given document contains images that should be considered potentially unauthorized. In one embodiment, the checker 170 also provides information that is useful for a human in determining whether such a document actually is unauthorized. For example, if an original URL (Uniform Resource Locator) of a similar image is stored in the model 160, a user can attempt to retrieve an image using that URL and use the retrieved image to determine whether the image in question is indeed a derivative of the one at the URL.

FIG. 2 is a system 200 for monitoring documents in an enterprise in accordance with an exemplary embodiment of the present invention.

As shown, the monitor 150 receives inbound images (including images contained within documents and archives) and registers with an image database 210 (shown in FIG. 1 as model 160). Images are detected or seen in documents of various formats, such as Word files, PowerPoint files, PDF files, Jar files, ZIP files, etc., and these can have images directly embedded within them. The registration involves computing a cryptographic hash (e.g., by means of a cryptographic hash algorithm such as MD5 or SHA-1) of the image and ensuring that an image location table 220 contains a row containing that hash (the “key”) and the URL from which the document was retrieved. The image location table 220 may contain a tag field and more than one URL associated with a given hash. The tag is used for maintaining the image location table. When the monitor 150 finds an image whose key is the same as one in the table 220, it checks the tag and URL. If the image is registered as “external” and the new image is found in a public domain URL, this means the image is public domain. Therefore, the URL and tag for this image are updated.

The checker 170 checks documents to determine whether they contain images seen by the monitor 150. When the checker 170 inputs documents, it invokes a document parser 230 that parses the documents and extracts images. In one embodiment, the parser is logically part of the checker. Cryptographic hashes are calculated from these images. This list of hash values of extracted images 240 is an intermediate output of the document parser 230.

Next, the checker 170 checks to see whether these hash values are found in the image-location table 220. If some images are found in the table and the corresponding URLs include ones that refer to sources outside the enterprise, the checker 170 decides that the input images or documents are potentially subject to ownership or copyright problems.

The monitor 150 is the component responsible for identifying images that are known to exist outside the enterprise. One exemplary way to do this is to interpose an “interceptor” to note images as they pass into the enterprise from outside of the enterprise. Two exemplary ways for images to enter an enterprise are through the web (as images displayed on web pages or contained in retrieved documents or archives) and through email (as or contained in attachments to inbound messages).

To handle web images, an HTTP proxy is used. Similar proxies (often the same instance) can be used to handle other protocols, such as FTP (File Transfer Protocol) or NNTP (Network News Transfer Protocol). Such proxies exist in the enterprise to improve performance by caching content that is asked for again (perhaps by another user) and also to enforce policies as to the type of content that is allowed to be imported and sites that are allowed to be visited. In one embodiment, the monitor 150 is included into an existing proxy (e.g., as a plug-in) or daisy-chained onto an existing proxy structure. In addition to noting explicitly-requested images, one exemplary embodiment has the web-proxy monitor also decompose other retrieved content that contain documents. Such content includes, for example, documents such as word-processing, presentation, or spreadsheet files, formatted documents (e.g., PDF files: Portable Document Format), or archives (e.g., ZIP, JAR, TAR, or RAR files). Files seen to be compressed are uncompressed and files seen to be encrypted are (if possible) decrypted. Note that the nesting may be arbitrarily deep, as with an image contained within a PDF file contained within a ZIP archive.

In some cases, if the processing required for a file is too expensive to perform without excessively impacting the performance of the proxy, the monitor stores a local copy of the retrieved image or document and the processing subsequently takes place at a more convenient time. If the proxy already includes a mechanism for caching content, this mechanism is used to store the local copy. This could (if allowed) mean that by the time images in the cache are processed, some images are no longer be there, which decreases the ability of the system, but the tradeoff can often be worthwhile.

In one exemplary embodiment, the monitor tracks or stores the source of the image (e.g., the URL used to retrieve image or the document or archive that contained the image). If the image originated from a web site within the enterprise, the image did not actually enter the enterprise. In this instance, the image is not potentially unauthorized and hence not treated as such in the model. The fact that the image occurs on an internal web site, on the other hand, provides no guarantee of copyright ownership or right to use. However, an exception occurs if the particular internal web site was known to use a tool that provided a guarantee or assurance that images contained within it are known to be externally usable without copyright issues. In such a case, the monitor causes the model to reflect the fact that this image is known to be authorized. As a generalization of this, if an external web site is known to contain public-domain images or images that the enterprise has a license to use, any images coming through the proxy from that site are noted as being usable (i.e., not having copyright or right to use issues).

For images that enter the enterprise through email, a similar proxy-based scheme is, with the proxy sitting on the SMTP (Simple Mail Transfer Protocol) port rather than HTTP. In this embodiment, the images are not be sent directly, but are encapsulated within the message as attachments, using MIME (Multipurpose Internet Mail Extensions), and the proxy will need to extract them. In some cases, the images are actually included as external references (by URL), and the proxy can either download them itself or count on the fact that before a user can view (or save) the image, the image is downloaded via HTTP and the web proxy will get a chance to process the image. In one embodiment, multiple monitors exist in the same enterprise.

In one embodiment, the monitor is incorporated into the existing email system. The monitor then processes messages as they come into the enterprise, examines their attachments, and extracts any images they contain. For example, email attachments are more likely than web documents to be complex documents like spreadsheet or word processing files. An email-based monitor can also examine still-extant email that was received before the monitor was installed.

As with web monitors, email monitors consider the source of the email. Documents contained in email messages sent between members of the enterprise are not considered to be external images. With email, however, some images that come from outside the enterprise are not copyright problematic. Consider an example where user A, within the enterprise, sends a document containing an image to user B, outside the enterprise. B then forwards the document to user C, within the enterprise. The monitor is able to determine that the image should not count as an external image, since it could well have originated from A. For this reason, one embodiment uses timestamps of messages and monitors outbound messages user folders (such as “sent items” folders).

In addition to web and email, installed programs are another source of external documents. Many programs copy images to a disk of a user in the course of an installation or obtain them from outside during execution. Such images are considered potentially unauthorized (unless, of course, it is known that a license to use comes with the program, in which case they should be treated as authorized). To add images that come from such sources to the model, one embodiment uses a scanner (such as file scanner 125 shown in FIG. 1) that examines a specified set of directories (e.g., the directory tree rooted at “C:\Program Files”) and treats as external any images found there. Such a scanner can be a standalone program or can be integrated into any other scan, such as a backup scan, a metadata extraction scan, an indexing scan, or a virus-detection scan. In one embodiment, the scanner is periodically run on the entire identified portion of the file system or the scanner can be triggered to run on particular events, such as the completion of writing a file in such a location. If the file system is backed up or mirrored to another location, the scan can be performed on that other location instead of (or in addition to) being performed on the file system itself.

Local mailbox files (e.g., Microsoft Outlook PST files, Rmail files, or MH folders) are known to contain email messages. In some embodiments, a scanner as described above delegates processing of such files to the subsystem of the monitor 150 specialized for processing email.

In one embodiment, the scanner makes use of “tags” (for example, shown in image location table 220 of FIG. 2) or other metadata associated with files on a user's file system. For example, if a user associates a “Public Domain” tag with an image or set of images, such image or images are considered authorized. In one such embodiment, the scanner queries a database or other source of such information for the identities and/or content information of images associated with tags or other metadata indicative of such images being unauthorized or authorized.

In addition to copyright issues, an image may be unauthorized to use externally because it is sensitive (e.g., confidential, secret, private, classified, disclosing of personal information, or obtained under an agreement that mandates non-disclosure). In some embodiments the monitor 150 determines this sensitivity and causes the model 160 to reflect this determination.

In addition to the above methods, which take a passive approach to noting images as they come into the enterprise, the monitor in one exemplary embodiment takes a proactive approach and actively searches for images on external websites. For example, the monitor uses a “web crawler” or “spider” to follow links from known URLs and notes the images or documents that are discovered. These images or documents are then downloaded and processed as if they were explicitly requested.

In one exemplary embodiment, the monitor crawls internal or external websites of the enterprise and searches for images and documents. If the web sites are flagged in some way as having been vetted (e.g., by exemplary methods discussed herein or by assertion by an authorized individual), then the images they contain are considered to be authorized (e.g., not confidential, secret, private, classified, disclosing of personal information, or obtained under an agreement that mandates non-disclosure.) Otherwise, if a large corpus of images is discovered, one embodiment requests a judgment from a human as to whether the images contained there are meant to be usable externally. If so, the images are considered authorized.

The monitor 150 is not required to know the precise entry of an external image 180 that led to its use in an internal document 190 in order for the checker 170 to be able to identify the document as containing a potentially unauthorized image. Instead, exemplary embodiments use the idea that if an image (1) exists outside the enterprise and (2) is interesting enough to have been brought once into the enterprise, then it is likely that the image will again enter the enterprise (possibly involving a different user). Upon entering the enterprise on the subsequent entry, the image will be discovered.

The checker 170 examines documents and images that may or may not be unauthorized and gives a judgment about whether they are likely to be unauthorized. That is, the checker indicates whether the images appear to be overly similar to images identified as occurring external to the enterprise (and not known to be licensed by it or in the public domain).

The checker 170 can be queried for a single document or image or queried for multiple documents and images. For example, a query can include either a large collection of images (e.g., those about to be or recently copied to an externally-visible web site) or a document (as described above) that contains images. In either case, the checker identifies which (if any) of the images are potentially unauthorized. Secondary (and optional) tasks supported by some embodiments include (1) indicating a degree of likelihood that a given identified image is unauthorized and (2) providing information that may be useful in making a judgment as to whether to treat the image as unauthorized.

To process complex documents, the checker (or some tool run prior to it) parses the documents to identify and extract images contained in the document and also to extract location information to allow the checker to present unauthorized images in a way that they can be seen in context. By way of example, this includes page or slide numbers, byte offsets, bounding boxes, attachment numbers or identifiers, etc. Further, in one exemplary embodiment, the document decomposition is recursive, as in the case in which an email message contains as an attachment a ZIP archive which contains a PowerPoint presentation, which contains an image at a given location on a given slide.

In one embodiment, the checker 170 is a standalone tool, invoked by a user when he or she has reason to believe that a document will become externally visible. Alternatively, the checker is part of a background task that regularly scans files or folders identified as having the property that they should only contain externally visible files. In yet another embodiment, the checker is integrated (as a plug-in or as a basic feature) into content creation software, such as a presentation or publication software. In the case of email, the checker forms part of user software, such as an email application, server software, or, in the case of web-based email, as part of an HTTP proxy or part of a web browser.

When a potentially unauthorized document or image is identified, the user is notified. Such notification could be made by textual or auditory means, but will preferentially be made by a graphical user interface (GUI). For example, the user is presented with the image and, if possible, the external image it was found to be similar to. Also presented could be location information (e.g., “page 5”) or the image could be presented in context. If supported by the application, the image can be located within the application. In the case of a scan or when many documents are being checked at once, one embodiment presents the results as a report that is stored in a file or on a web site, printed on a printer, emailed, etc. In one embodiment, the checker (or software it communicates with) takes further action to prevent images from causing problems. Examples of such actions include deleting, moving, quarantining, or tightening access controls on the documents that contain them or bouncing or requesting explicit authorization before sending email.

One way to check whether a given image is similar to any images identified as potentially unauthorized is to determine whether it is identical to one of them. One embodiment compares identity by taking a cryptographic hash of each image and comparing the hashes for equality. Cryptographic hashes are reductions of large sequences of bits down to much smaller sequences, where the reductions have the properties that (1) they are deterministic, (2) they are easy and efficient to compute, (3) the resulting bit sequences are (essentially) uniformly distributed, (4) it is difficult or impossible to recover the original sequence given only the hash, and (5) the hashes are large enough that the probability of any two non-identical sequences of bits resulting the same hash code can be ignored. Examples of cryptographic hashes include MD-5, which results in a 128-bit (16-byte) hash value, and SHA-1, which results in a 160-bit (20-byte) hash value. If identity is used as the criterion, it suffices to keep (in the model) a list of all of the hashes that have been seen on potentially-unauthorized images, and to check by computing the hash of the image in question and looking to see if the hash is in the list. A benefit of such a representation is that other information can also be kept with the hash in the list. For instance, the URL from which an image was retrieved or perhaps the image itself (or a lower-resolution or otherwise compressed version of it) are saved. If the number of images is too large for this to be practical, the list can be kept smaller by keeping a subset and allowing images to “fall off”. One way to perform this task is to keep the list sorted by access time. Whenever an image is added, if an image with the same hash is already on the list, that entry is moved to the front (“most recent”) end. Otherwise, a new entry is created for the image at the front and (if there are a sufficient number of entries in the list) the entry at the back (“least recent”) is discarded. Other decision criteria can also be taken into account, such as the size of the image (indicative of the likelihood of use) or the nature of the source. Instead of maintaining a sorted list, a timestamp is associated with each entry. The timestamp is updated on access and the entry with the oldest timestamp removed (if necessary) when a new entry is added.

In another embodiment, identification (e.g., of the source or a cached version) of the external image is not supported. Rather, the exemplary embodiment merely supports the determination (perhaps without complete accuracy) that an image with that hash has been seen and the class (e.g., “potentially unauthorized” or “authorized”) associated with the image. In some such embodiments, the model 160 is implemented by means of a compact probabilistic representation, such as a Bloom filter. In this embodiment, a large number of entries are stored with a fixed space and a relatively small number of bytes (e.g., two or three) are used per entry. They have the property that whenever a lookup indicates that a given item (e.g., a hash) is not in the represented set, such an indication it is always correct, when a lookup indicates that the item is in the set, it is wrong with a tunable probability that is may be set arbitrarily low (e.g., one in ten thousand or one in a million).

While identity is simple to check and compact to store, identify alone may not be sufficient. This is because images are rarely simply used “as is” or without modification. Instead, images are often transformed before being used. Examples of such transformations include (but are not limited to) cropping, resizing, rotated, or mirroring, adjusting the color map, altering the resolution, overlaying text or other images overlaid, sharpening, blurring, fixing defects such as red-eye, converting from one image format to another, and changing metadata. (Similar lists of transformations apply to non-image objects. For instance, audio clips are subject to truncation, changing sampling rate, changing volume, etc.) These changes result in a derived image that has a different hash value from its source image. For all of these reasons, one exemplary embodiment determines that there are sufficiently-similar non-identical potentially unauthorized images.

One exemplary approach for determining similarity is to compute a number of features from the image, where a feature is any number or other data that partially characterizes the image in a way that can be used by an algorithm. The features are computed in such a way that an image derived from another image by one or more of the abovementioned modifications is likely to still have a fair number (though likely not all) of the same features. Further, the likelihood that one image is derived from another is in some way (although not necessarily linearly) proportional to the size of the overlaps of their sets of features. In some approaches, the features themselves are similar to one another, relative to some defined distance metric. In various embodiments, therefore, an overall similarity metric takes into account the number of features that are identical (or closer than some threshold) and the divergence between some or all of the rest and uses these factors to compute a single number (or set of numbers or discrete qualitative value) that indicates a degree of similarity between one image and another.

As with identity, one exemplary approach is for the model to contain a table of entries for the images seen, with each entry containing a representation of the image's features. To avoid extracting features from images already in the table, one embodiment maintains an identity hash and reuses features previously extracted when an entry having an identical identity hash is found in the table. To look up an image, its features are extracted and the table is scanned. A similarity measure is then computed for each image represented in the table until either a sufficiently highly similar entry is found or the table is exhausted. In one embodiment in which the similarity measure involves the number of identical features an initial query is made to identify images in the table that have any features in common with the image in question, and the full similarity computation is performed only on the restricted set of images returned.

In one embodiment, the feature set representation is a Bloom filter or other similar non-authoritative representation from which a degree of overlap may be approximated.

In an alternative embodiment, the model 160 comprises a set of one or more detectors (a.k.a. “patterns”, “rules”, “classifiers”, “recognizers”, or “decision functions”) that can be applied to an image, either directly or to a set of features computed based on it. In one such embodiment, the checker 170 applies some or all of the detectors to the image in question (or to features computed based on it). If any (or a sufficient number) assert detection (alternatively “match”, “recognize”), the image is declared to be potentially unauthorized. The set of detectors is created by applying a learning algorithm (e.g., k-nearest neighbor, Näive Bayes, C4.5, Support Vector Machine, genetic algorithm, genetic programming) to a training set comprising images (or features computed based on images) seen by the monitor 150, where these images comprise those believed to be potentially unauthorized, those believed to be authorized, and those merely not believed to be potentially unauthorized, and where the goal of the learning task is to derive a set of detectors that maximize the number of potentially unauthorized images recognized while minimizing the number of authorized images recognized. The set of detectors is retrained (either incrementally or from scratch) as new images are seen, and this retraining can happen each time an image is seen or periodically (as once an hour or once a day).

In a variant of the prior embodiment, the set of detectors is trained so as to minimize the recognition of potentially unauthorized images while maximizing the recognition of authorized images. In this embodiment, the checker 170 declares an image to be potentially unauthorized if no detector (or not more than a threshold number of detectors) recognize the image. In an alternative embodiment, the set of detectors is not trained. Rather, a set of detectors is created in a randomized manner. If it matches all (or more than a small number of) retained potentially unauthorized images, it is discarded. If it fails to match any (or a threshold number of) retained authorized images, it is also discarded. When the monitor 150 encounters a new potentially unauthorized image, it checks it against some or all of the detectors in the model 160, discarding any that match (or that now match too many potentially unauthorized images) and causing the generation and testing of a new randomized detector or one created by perturbing an existing detector (possibly the detector being discarded). New images are also probabilistically added to the set of retained images, perhaps replacing other retained images. In one embodiment, once a detector has passed its initial test, its parameters are perturbed in order to attempt to obtain a detector that matches more authorized images while not increasing (and ideally decreasing) the number of potentially unauthorized images matched.

While the checker has been described as being internal to an enterprise, exemplary embodiments are not limited to this arrangement. The model built up by the monitor (whether running inside various enterprises or by crawling the web) can be shared among several enterprises or held by a third party. The model can be used by checkers either by having the model itself distributed to each subscribing enterprise or by having the checker run as a service (e.g., a web-based service) taking as input images (or documents) or their features.

Exemplary embodiments enable an enterprise to reduce its risk due to malicious or inadvertent public use of content to which others hold copyright or which contain sensitive information that should not be shared outside the enterprise. They make it possible to be confident that a disclosure will not be a problem even when some of its content comes from unknown sources. Further, exemplary embodiments provide for methods of notifying of potential problems before content is published. Material already published can also be scanned. Furthermore, exemplary embodiments reduce the burden on users by leveraging their behavior (e.g., web browsing, receiving email, etc) to identify images that may result in problems rather than making them keep track of what came from where.

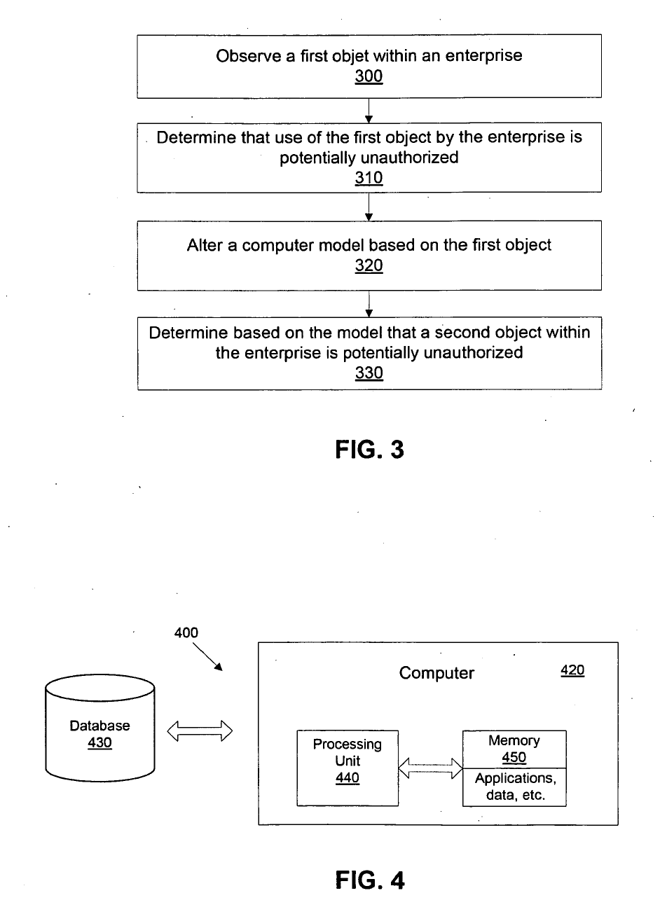

FIG. 3 is a flow diagram for determining a suitability for use of objects in an enterprise in accordance with an exemplary embodiment.

According to block 300, an object is observed within an enterprise. For example, one embodiment tracks or monitors documents, images, or objects as they enter into the enterprise from locations outside of the enterprise.

According to block 310, a determination is made that use of the object by the enterprise is potentially unauthorized.

According to block 320, a computer model is altered based on the object.

According to block 330, a determination is made, based on the model, that a second object within the enterprise is potentially unauthorized.

The following example illustrates an exemplary embodiment wherein the objects include documents, such as one or more images. Initially, the images are observed entering the enterprise. Then, a model is built from characteristics in the images. By way of example, characteristics of the images are stored in a database. These characteristics include, but are not limited to, metadata about the image, the actual image itself or a copy of the image, cryptographic hashes of the content of the image, features computed based on the image, history of when the image entered the enterprise, a location or origin of the image outside of the enterprise, etc. These characteristics are stored in the model. Subsequently a determination is made as to whether a second image in the enterprise was derived from images that originated in the enterprise or images that originated outside of the enterprise. The second image is compared with images stored in the model. If the second image originated in the enterprise, then the document is likely authorized (for example, the enterprise has a right to use the image and/or the image is not subject to copyright of a third party, such as a non-enterprise employee).

By way of example, the image is compared with the characteristics to determine a similarity. In one exemplary embodiment, the hash codes are compared to determine similarities and/or differences between the document under investigation and the existing characteristics stored in the model. Two different documents, for example, can be similar even though the two documents are not identical. As used herein, the term “similar” or “similarity” means having characteristics in common and/or closely resembling each other. Thus, two documents are similar if they are identical or if they have characteristics or substance in common.

By way example, after an image originating outside of the enterprise enters the enterprise, its characteristics are stored in the model and then it is transmitted to a user in the enterprise. Subsequently, the user or another user updates or modifies the image to produce a modified or revised version of the image. This revised version of the image can remove material included in the earlier version or add new material not included in the first version. The addition of new material or subtraction of material can be minor (such as small edits) or major (such as adding or subtracting to the image). Although the original and revised versions of the image are not identical, the two versions can be similar.

Various determinations can be utilized to determine when two documents are similar. In one exemplary embodiment, if a similarity score exceeds a pre-defined threshold, then the documents are similar; otherwise, the documents are dissimilar.

According to block 340, a user is notified of an origin of a document. For example, if the document originated in the enterprise or originated outside of the enterprise, the user is notified of this fact. If the document originated outside of the enterprise, this notification indicates to the user that the document could be unauthorized (for example, the enterprise does not have a right to use the document, the document could be owned by a third, and/or the document is subject to a third-party copyright).

In one embodiment, the user affirmatively requests a determination as to whether the document is unauthorized. For example, a user receives or acquires an image in the enterprise and submits a query to determine whether the image originated in the enterprise or outside the enterprise. Alternatively, this determination can be automatically performed (i.e., with a request from a user).

If a document or image is potentially unauthorized (for example, originated outside of the enterprise), then the user can change or substitute the suspicious document or image with another document or image, such as an original image, an image known to be legal property of the enterprise, or an image that the enterprise has a legal right to use.

Embodiments in accordance with the present invention are utilized in or include a variety of systems, methods, and apparatus. FIG. 4 illustrates an exemplary embodiment as a computer system 400 for being or utilizing one or more of the computers, methods, flow diagrams and/or aspects of exemplary embodiments in accordance with the present invention.

The system 400 includes a computer system 420 (such as a host or client computer) and a repository, warehouse, or database 430 (for example, for storing characteristics of documents entering the enterprise). The computer system 420 comprises a processing unit 440 (such as one or more processors or central processing units, CPUs) for controlling the overall operation of memory 450 (such as random access memory (RAM) for temporary data storage and read only memory (ROM) for permanent data storage). The memory 450, for example, stores applications, data, control programs, algorithms (including diagrams and methods discussed herein), and other data associated with the computer system 420. The processing unit 440 communicates with memory 450 and data base 430 and many other components via buses, networks, etc.

Embodiments in accordance with the present invention are not limited to any particular type or number of databases and/or computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

Definitions:

As used herein and in the claims, the following words have the following definitions:

The terms “automated” or “automatically” (and like variations thereof) mean controlled operation of an apparatus, system, and/or process using computers and/or mechanical/electrical devices without the necessity of human intervention, observation, effort and/or decision.

A “database” is a structured collection of records or data that are stored in a computer system so that a computer program or person using a query language can consult it to retrieve records and/or answer queries. Records retrieved in response to queries provide information used to make decisions.

Copyright, as used in the specification and claims is intended to retain its statutory and common law definitions as defined in either the U.S. or internationally. This includes United States Code Title 17.

The term “document” means a writing or image that conveys information, such as an electronic file or a physical material substance (example, paper) that includes writing using markings or symbols. Documents and articles can be based in any medium of expression and include, but are not limited to, magazines, newspapers, books, published and non-published writings, pictures, images, text, etc. Electronic documents can also include video and/or audio files or links.

The term “enterprise” includes individuals, businesses, and operational entities that may or may not provide goods and/or services to consumers or corporate entities, such as governments, charities, or other businesses.

The term “file” has broad application and includes electronic articles and documents (example, files produced or edited from a software application), collection of related data, and/or sequence of related information (such as a sequence of electronic bits) stored in a computer. In one exemplary embodiment, files are created with software applications and include a particular file format (i.e., way information is encoded for storage) and a file name. Embodiments in accordance with the present invention include numerous different types of files such as, but not limited to, image and text files (a file that holds text or graphics, such as ASCII files: American Standard Code for Information Interchange; HTML files: Hyper Text Markup Language; PDF files: Portable Document Format; and Postscript files; TIFF: Tagged Image File Format; JPEG/JPG: Joint Photographic Experts Group; GIF: Graphics Interchange Format; etc.), etc.

The terms “similar” or “similarity” mean having characteristics in common and/or closely resembling each other. Thus, two documents are similar if they are identical or if they have characteristics or substance in common. Two different documents, for example, can be similar even though the two documents are not identical.

In one exemplary embodiment, one or more blocks or steps discussed herein are automated. In other words, apparatus, systems, and methods occur automatically.

The methods in accordance with exemplary embodiments of the present invention are provided as examples and should not be construed to limit other embodiments within the scope of the invention. For instance, blocks in flow diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
observing a first object within an enterprise;
determining that use of the first object by the enterprise is potentially unauthorized;
altering a computer model based on the first object; and
determining based on the model that a second object within the enterprise is potentially unauthorized.

2) The method of claim 1 wherein observing the first object comprises observing the first object at an entry point to the enterprise.

3) The method of claim 2 wherein observing the first object is integrated with one of: a proxy server, an e-mail server, a backup system, and a scanner.

4) The method of claim 1 wherein observing the first object comprises observing a document that contains the object.

5) The method of claim 1 wherein determining that the first object is potentially unauthorized comprises checking metadata associated with the first object.

6) The method of claim 1 wherein determining that the second object is potentially unauthorized comprises determining a degree of similarity between the first object and the second object.

7) The method of claim 6:
wherein altering the model comprises deriving a first set of features from the first object and storing the first set of features in the model; and
wherein determining the degree of similarity comprises:
deriving a second set of features from the second object; and
comparing the first set of features with the second set of features.

8) The method of claim 1 further comprising extracting the second object from a document containing the second object.

9) The method of claim 1 wherein the model comprises a set of detectors and wherein determining that a second object is potentially unauthorized comprises applying a detector from the set of detectors to the second object.

10) The method of claim 10 further comprising observing a plurality of objects and determining a subset of the plurality of objects that are potentially unauthorized, the method further comprising deriving the set of detectors based on the subset of potentially unauthorized objects.

11) The method of claim 1 further comprising communicating the determination that the second object is potentially unauthorized.

12) The method of claim 12 wherein determining that the second object is potentially unauthorized comprises determining that the second object is sufficiently similar to the first object and wherein communicating the determination comprises presenting a representation of the first object.

13) The method of claim 1 further comprising observing a third object;
determining that the third object is authorized; and
altering the model based on the third object.

14) A tangible computer readable storage medium having instructions for causing a computer to execute a method, comprising:
observing a first object within an enterprise;
determining that use of the first object by an enterprise is potentially unauthorized;
altering a computer model based on the first object; and
determining based on the model that a second object within the enterprise is potentially unauthorized.

15) A computer system, comprising:
a database;
a memory for storing an algorithm; and
a processor for executing the algorithm to:
observe a first object within an enterprise;
determine that use of the first object by an enterprise is potentially unauthorized; alter a computer model based on the first object; and
determine based on the model that a second object within the enterprise is potentially unauthorized.
